(19) United States
(12) Patent Application Publication
(10) Pub. No.: US 2003/0098590 A1
(43) Pub. Date: May 29, 2003

(54) Vertical truck bed extender

(76) Inventor: John J. Chechuck, Burgettstown, PA (US)

Correspondence Address: Wheeler Law Offices, P.C., P.O. Box 22035, Pittsburgh, PA, 15222, US

(21) Appl. No.: 09/997,352

(22) Filed: Nov. 29, 2001

(51) Int. Cl. B62C 1/06

(52) U.S. Cl. 296/26.04

(57) ABSTRACT

A vertical truck bed extender is described herein. Said vertical truck bed extender lengthens the height of the perimeter walls of a truck bed. The vertical truck bed extender is preferably constructed of aluminum and is removable and reusable. It includes four separate panels that are attached to one another as well as directly to the truck bed walls.

### FIELD OF THE INVENTION

The present invention relates generally to pickup truck accessories. More specifically, the present invention relates to a pickup truck bed extender that vertically extends the perimeter walls of a truck bed.

### BACKGROUND OF THE INVENTION

Often times, owners of pickup trucks need to haul big bulky loose items such as mulch or sawdust. One hazard of doing this in a typical pickup is that the truck owner must be aware of the amount that he/she can transport at one time and is limited by the height of the truck bed walls. This can force a truck owner to waste time and money making two or more trips to haul the load. Renting a larger truck is often very costly and buying a larger truck can be impractical if the need to haul large loads only occurs every now and again. Consequently, the need exists for a device that a truck owner can use to vertically extend the height of the truck bed when necessary. The present invention fulfills this need.

### SUMMARY OF THE INVENTION

The present invention, the vertical truck bed extender, is devised to extend the vertical walls of a pickup truck bed when needed. The vertical truck bed extender is preferably constructed of polished aluminum so that it is aesthetically pleasing as well as durable and lightweight. It includes four panels, three of which bolt to the inside vertical lip of any typical pickup truck. The fourth panel bolts to a set of rear caps that are welded to the side panels thus allowing continued operation of the tailgate.

It is an object of the present invention to provide a device that extends the vertical walls of a pickup truck bed.

It is a further object of the present invention to provide a device that allows pickup truck owners and users to carry larger loads or larger single items in their pickup trucks when necessary, not to exceed the G.V.W. of the pickup truck.

It is another object of the present invention to provide a device that vertically extends the walls of a pickup truck and is practical, yet aesthetically pleasing.

It is another object of the present invention to provide a vertical truck bed extender that is removable and reusable.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the outside of a pickup truck bed with the vertical truck bed extender installed.

FIG. 2 is a perspective view of one wall of the inside of a pickup truck bed with the vertical truck bed extender installed.

FIG. 3 is a side view of the left panel.

FIG. 4 is a perspective view of the front panel.

FIG. 5 is a front view of the rear panel.

### DETAILED DESCRIPTION OF THE INVENTION

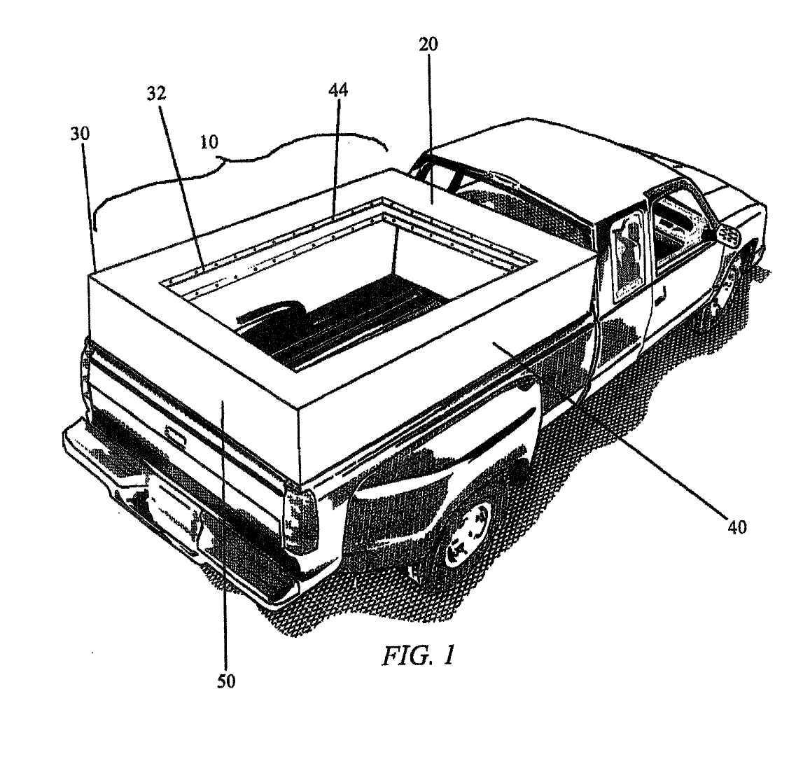

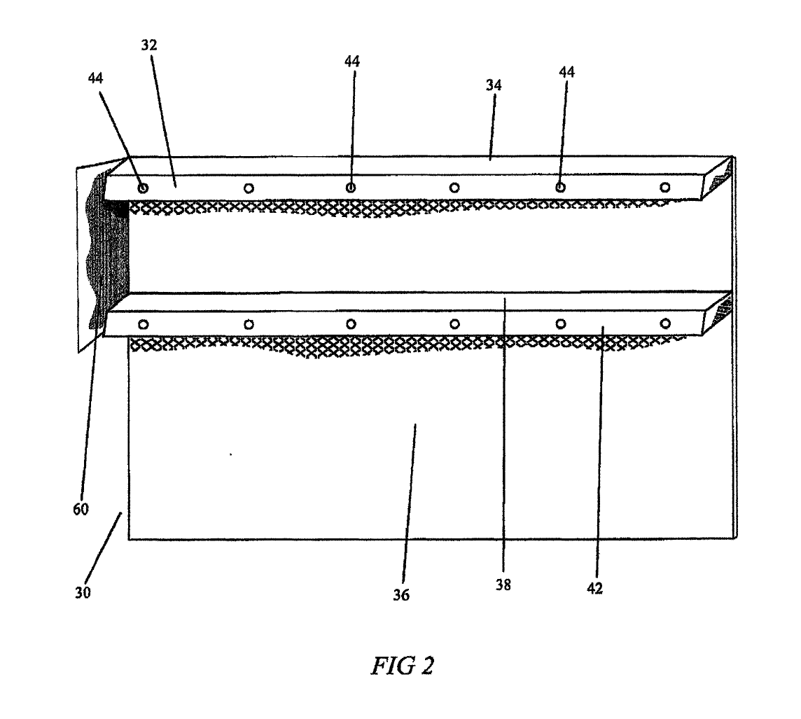

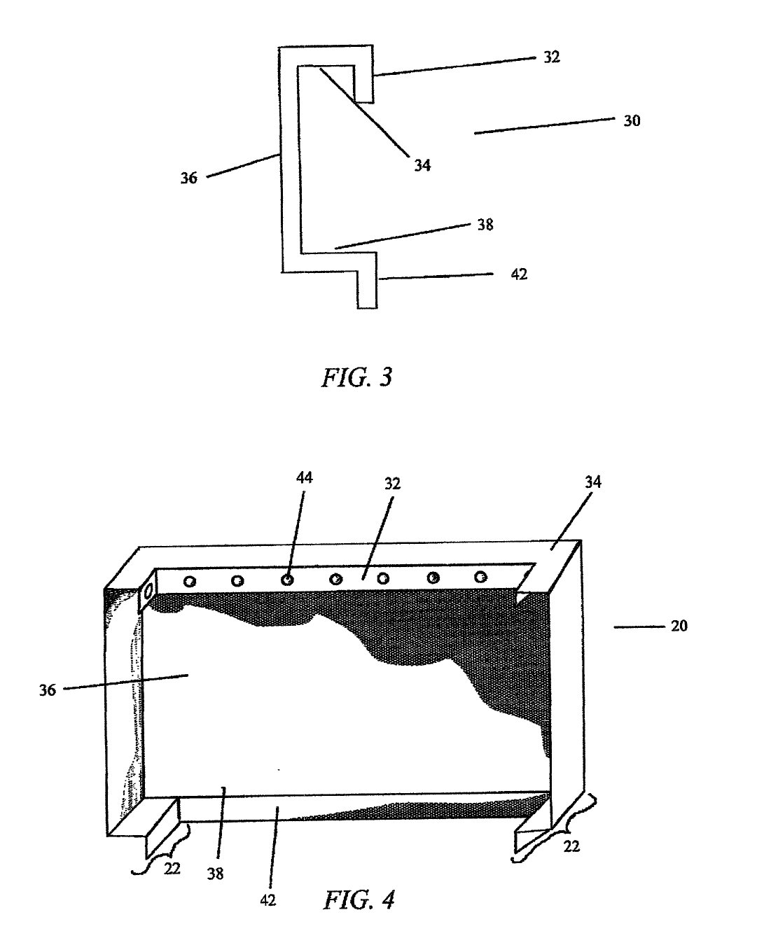

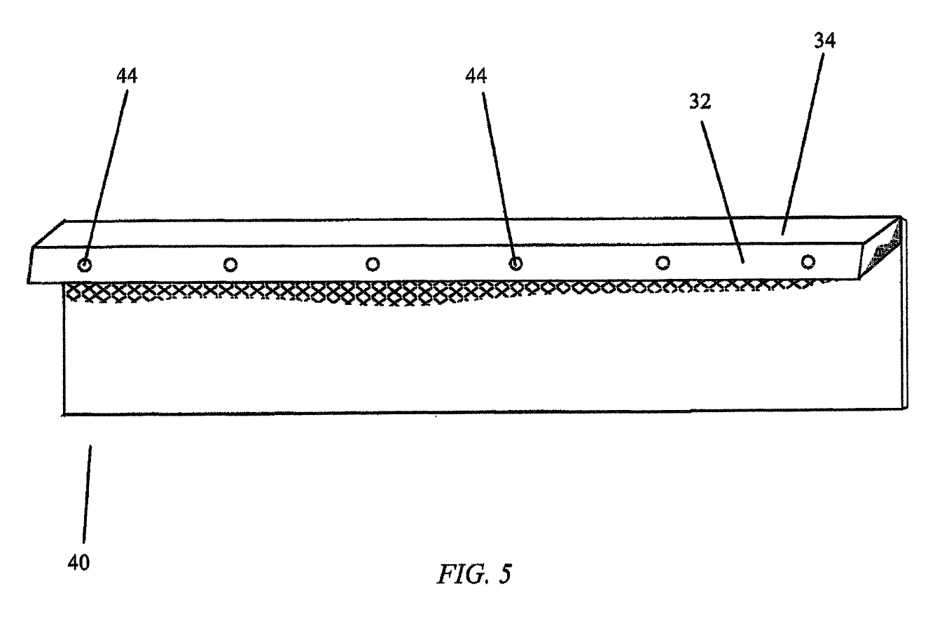

The preferred embodiment of the present invention, the vertical truck bed extender 10, is shown attached to the bed of a pickup truck in FIG. 1. As can be seen, in the preferred embodiment, the vertical truck bed extender 10 includes four separate panels: a front panel 20, a left panel 30, a right panel 40 and a rear panel 50 that are bolted together. It is preferred that the vertical truck bed extender 10 consist of four separate panels in order to better aid in the placement and removal thereof, ensuring that the device can be used and reused on a temporary basis when needed. In an alternative embodiment, however, all four sides are welded together for a permanent bond and then installed in much the same way as the preferred embodiment as is hereinafter described.

It is preferred that polished aluminum be used to construct all of the four panels 20, 30, 40 and 50. Polished aluminum is economical, lightweight, durable and weathers soundly. It is also more aesthetically pleasing then many alternative materials. One of ordinary skill in the art would readily recognize, however, that the four panels 20, 30, 40 and 50 can be constructed of a number of other materials, including, but not limited to, steel or a durable plastic.

In the preferred embodiment, both the left panel 30 and the right panel 40 have a first vertical rise 42, preferably two inches in length, and a first horizontal plateau 38 stemming back from the top of the first vertical rise 42, also preferably two inches in length. In the preferred embodiment, on the right panel 40, the first horizontal plateau 38 travels outward to the right, whereas on the left pane 30, the first horizontal plateau 38 travels outward to the left. On both the left panel 30 and the right panel 40, the first horizontal plateau 38 is followed by a variable second vertical rise 36, preferably at least twelve inches in length. In the preferred embodiment, a second horizontal plateau 34 stems forward from the top of the second vertical rise 36 inward to the left on the right panel 40 and inward to the right on the left panel 30. The second horizontal plateau 34 is preferably two inches in length. A first vertical drop 32 stems from the end of the second horizontal plateau 34, preferably two inches in length. The first vertical drop 32 is located at the top of the left panel 30 or right panel 40 when installed in a pickup truck.

In the preferred embodiment, the first vertical drop 32 has apertures 44 cut therethrough allowing for the straps of a tarp or cover to be hooked or fed through and tied. It is preferred that said apertures 44 be about one half inch in diameter although their size can vary. Further, the specified vertical rise, drop and plateaus 42, 32, 34 and 38, are preferably two inches long in correspondence with the two inch plateau and two inch vertical lip atop a typical pickup truck bed wall. One of ordinary skill in the art would readily recognize, however, that the vertical rise, drop and horizontal plateaus 42, 32, 34 and 38 can be sized differently for different sized pickup trucks.

The second vertical rise 36 is the extension of the truck bed wall. In a preferred embodiment, this rise is twelve inches in height. One of ordinary skill in the art would recognize however, that this height can vary depending on the needs of the user.

In the preferred embodiment, both the left panel 30 and the right panel 40 have caps 60 welded to one side of the panel. It is preferred that the caps 60 are welded to the left panel 30 and the right panel 40 at the ends thereof nearest the tailgate when installed in the bed of a pickup truck, such that the caps 60 extend inward toward the truck bed perpendicularly from the panels 30 and 40. The caps 60 are extensions, preferably two inches wide, although the size can vary, that allow the rear panel 40 to be attached above the tailgate 70. The caps 60 like the panels 20, 30, 40 and 50, are preferably constructed from polished aluminum, although as mentioned, can be constructed from a number of other materials. In the preferred embodiment, the caps 60 have handles (not shown) that one can use to help him/herself into the pickup truck bed.

In the preferred embodiment, the front panel 20, when installed, is located against the front of the truck bed. In the preferred embodiment, the front panel 20 preferably has the same vertical rise and drop and horizontal plateau configuration as both the left panel 30 and the right panel 40 and also has apertures 44 for fastening a tarp or cover thereto. In addition, however, the front panel 20 has folds 22 at each end thereof. The folds 22 reinforce the front corners by slightly overlapping the interiors of the left panel 30 and right panel 40.

The rear panel 50 is not configured exactly like the other panels 20, 30 and 40. The rear panel 50 is missing the first horizontal plateau 38 and first vertical rise 42 because it does not attach directly to the truck bed. Instead, it is bolted to the caps 60 located at the ends of the left panel 30 and the right panel 40. This allows for continued use of the tailgate of the truck. It is preferred that only a slight clearance be left between the top of the tailgate 70 and the bottom of the rear panel 50; just enough to allow the tailgate 70 to open. If too large of a gap is left, the user risks loss of materials through the gap during transport.

To install the vertical truck bed extender 10, it is preferred that the user begin by bolting the right panel 40 onto the right wall of the truck bed. Right, for purposes herein, is determined by standing at the tailgate 70 of the truck while facing the truck cab. The first horizontal plateau 38 overlaps the horizontal plateau of the top of the pickup truck bed wall and the first vertical rise 42 overlaps the vertical lip located on the inside of the pickup truck bed wall. The right panel 40 is installed by fastening the first vertical rise 42 to the vertical lip of the truck. It is preferred that the panels 20, 30, 40 and 50 are bolted instead of welded to the walls of the pickup truck and to each other, so that they are removable. For a more permanent embodiment, however, the panels can be welded directly to the truck bed.

Next, the front panel 20 is installed with the right fold 22 overlapping the interior side, truck bed side, of the right panel 40. The front panel 20 is fastened like the right panel 40 and then the left panel 30 is installed in exactly the same way, again overlapping the left fold 22 of the front panel 20 with the interior side of the left panel 30. Lastly, the rear panel 50 is fastened to the caps 60. One of ordinary skill in the art would readily recognize, that other removable and/or permanent fastening materials such as screws, can be used, instead of bolts, to fasten the panels 20, 30, 40 and 50 to the pickup truck bed walls and to each other.

Although this invention has certain preferred embodiments, it will be obvious to those skilled in the art that various changes and modifications may be made therein without departing from the invention, and all such changes and modifications are intended to fall within the true spirit and scope of the invention.

What is claimed is:

1. A vertical truck bed extender comprising:
a first side panel, for coupling to the side truck bed walls of a pickup truck, said first side panel having a first vertical rise and a first horizontal plateau stemming from the end of said first vertical rise and a second vertical rise stemming from the end of said first horizontal plateau and an inward facing extension plank extending perpendicularly from said second vertical rise, in a direction opposite that of the first horizontal plateau, at one end of the first side panel;
a second side panel, for coupling to the side truck bed walls of a pickup truck, said second side panel having a first vertical rise, said first vertical rise equal in length to the first vertical rise of the first side panel, and a first horizontal plateau stemming from the end of said first vertical rise in a direction opposite the first horizontal plateau of the first side panel, said first horizontal plateau equal in length to the first horizontal plateau of the first side panel, and a second vertical rise stemming from the end of said first horizontal plateau said second vertical rise equal in length to the second vertical rise of the first side panel, and an inward facing extension plank extending perpendicularly from said second vertical rise, in a direction opposite that of the first horizontal plateau, at one end of the second side panel;
a rear panel coupled to the extension planks of the first and second side panels.

2. The vertical truck bed extender of claim 1 wherein said rear panel is removably coupled to the extension planks of the first and second side panels.

3. A vertical truck bed extender comprising:
a first side panel, for coupling to the side truck bed walls of a pickup truck, said first side panel having a first vertical rise and a first horizontal plateau stemming from the end of said first vertical rise and a second vertical rise stemming from the end of said first horizontal plateau and an inward facing extension plank extending perpendicularly from said second vertical rise, in a direction opposite that of the first horizontal plateau, at one end of the first side panel;
a second side panel, for coupling to the side truck bed walls of a pickup truck, said second side panel having a first vertical rise, said first vertical rise equal in length to the first vertical rise of the first side panel, and a first horizontal plateau stemming from the end of said first vertical rise in a direction opposite the first horizontal plateau of the first side panel, said first horizontal plateau equal in length to the first horizontal plateau of the first side panel, and a second vertical rise stemming from the end of said first horizontal plateau said second vertical rise equal in length to the second vertical rise of the first side panel, and an inward facing extension plank extending perpendicularly from said second vertical rise, in a direction opposite that of the first horizontal plateau, at one end of the second side panel;
a front panel, for removably coupling to the front truck bed wall of a pickup truck, said front panel having a first vertical rise, said first vertical rise equal in length to the first vertical rise of the first side panel, and a first horizontal plateau stemming from the end of said first vertical rise in an outward direction from the truck bed, said first horizontal plateau equal in length to the first horizontal plateau of the first side panel, and a second vertical rise stemming from the end of said first horizontal plateau said second vertical rise equal in length to the second vertical rise of the first side panel; and,
a rear panel coupled to the extension planks of the first and second side panels.

4. The vertical truck bed extender of claim 3 wherein said rear panel is removably coupled to the extension planks of the first and second side panels.

5. A vertical truck bed extender comprising:
a first side panel, for coupling to the side truck bed walls of a pickup truck, said first side panel having a first vertical rise and a first horizontal plateau stemming from the end of said first vertical rise and a second vertical rise stemming from the end of said first horizontal plateau and a second horizontal plateau stemming from the end of the end of the second vertical rise in a direction opposite that of the first horizontal plateau and a first vertical drop and an inward facing extension plank extending perpendicularly from said second vertical rise, in a direction opposite that of the first horizontal plateau, at one end of the first side panel;
a second side panel, for coupling to the side truck bed walls of a pickup truck, said second side panel having a first vertical rise, said first vertical rise equal in length to the first vertical rise of the first side panel, and a first horizontal plateau stemming from the end of said first vertical rise in a direction opposite that of the first horizontal plateau of the first side panel, said first horizontal plateau equal in length to the first horizontal plateau of the first side panel, and a second vertical rise stemming from the end of said first horizontal plateau said second vertical rise equal in length to the second vertical rise of the first side panel, and a second horizontal plateau stemming from the end of said second vertical rise in a direction opposite that of the first horizontal plateau of the second side panel, said second horizontal plateau equal in length to the second horizontal plateau of the first side panel and a first vertical drop, said first vertical drop equal in length to the first vertical drop of the first panel and an inward facing extension plank extending perpendicularly from said second vertical rise, in a direction opposite that of the first horizontal plateau of the second side panel, at one end of the second side panel;
a front panel, for removably coupling to the front truck bed wall of a pickup truck, said front panel having a first vertical rise, said first vertical rise equal in length to the first vertical rise of the first side panel, and a first horizontal plateau stemming from the end of said first vertical rise in an outward direction from the truck bed, said first horizontal plateau equal in length to the first horizontal plateau of the first side panel, and a second vertical rise stemming from the end of said first horizontal plateau said second vertical rise equal in length to the second vertical rise of the first side panel, and a second horizontal plateau stemming from the end of the second vertical rise in a direction opposite that of the first horizontal plateau of the front panel, said second horizontal plateau equal in length to the second horizontal plateau of the first side panel, and a first vertical drop, said first vertical drop equal in length to the first vertical drop of the first panel, and two extension panels, one extension panel extending perpendicularly from each side of the second vertical rise portion of the front panel as a continuation thereof and forming a “u” shape with the original second vertical rise portion of the front panel; and,
a rear panel removably coupled to the extension planks of the first and second side panels.

6. The vertical truck bed extender of claim 5 wherein the vertical drop of the first side panel and the vertical drop of the second side panel and the vertical drop of the front panel have apertures therethrough evenly spaced along the length thereof.

7. The vertical truck bed extender of claim 5 wherein the rear panel has a first vertical rise, said first vertical rise equal to the second vertical rise of the first side panel, a first horizontal plateau stemming from the end of the first vertical rise in a direction opposite that of the second horizontal plateau of the front panel, said first horizontal plateau equal in length to the second horizontal plateau of the first side panel and a first vertical drop, said vertical drop equal in length to the first vertical drop of the first side panel and said vertical drop having apertures therethrough evenly spaced along the length thereof.
